(19) United States
(12) Patent Application Publication
(10) Pub. No.: US 2007/0177769 A1
(43) Pub. Date: Aug. 2, 2007

(54) Information processing device and authentication method

(76) Inventors: Hiroyuki Motoyama, Yokohama (JP); Keiji Kitane, Ebina (JP)

Correspondence Address: MCDERMOTT WILL & EMERY LLP, 600 13TH STREET, N.W., WASHINGTON, DC, 20005-3096, US

(21) Appl. No.: 11/606,366

(22) Filed: Nov. 30, 2006

(30) Foreign Application Priority Data
Nov. 30, 2005 (JP) 2005-344881

(51) Int. Cl. G06K 9/00

(52) U.S. Cl. 382/115

(57) ABSTRACT

The present invention provides an information processing device includes: a biometrics device, an interface control unit for controlling the biometrics device, a first storage unit for concealing a user identifier and user authentication information, a second storage unit for storing a program executed by the information processing device, and a processor for releasing the concealment of the first storage unit based on the program stored in the second storage unit and acquiring biometrics information inputted from the biometrics device, so as to compare it with the user authentication information. Thus, it is possible to prevent lowering of user-friendliness and increase of the cost when using an external authentication device in a laptop type personal computer and to provide an authentication control configuration and an authentication procedure optimal for an information processing device such as a laptop type personal computer.

### INCORPORATION BY REFERENCE

The present application claims priority from Japanese application JP2005-344881 filed on Nov. 30, 2005, the content of which is hereby incorporated by reference into this application.

### BACKGROUND OF THE INVENTION

The present invention relates to an information processing device such as a laptop type personal computer and in particular, to a hardware configuration or a control method for appropriately mounting an authentication device.

Recently, there often arises a problem of leak of personal information and other confidential information due to a theft or a loss of a laptop. Organizations handling personal information such as enterprises and communities care about the social information security.

Conventionally, in a laptop type personal computer, a log-in screen is displayed upon rise of an OS so that only a particular user can use it. The log-in method is a method for inputting a password through a keyboard operation. For this, in order to enhance the security, a password of high concealment should be set and there is a problem that a user has a difficulty to memorize his/her password.

People are highly conscious that it is necessary to prevent an unauthorized access by spoofing by a third person. More and more news are appearing on the use of biometrics information such as a fingerprint and a vein pattern as a key for authentication of an individual's identity. For example, JP-A-2005-128936 discloses a biometrics technology using a part of a human body as a key, i.e., finger vein authentication.

### SUMMARY OF THE INVENTION

However, the authentication device disclosed in JP-A-2005-128936 is connected outside of an information processing device, which lowers the user-friendliness of the information processing device. Especially in the case of laptop type personal computer, the external size is increased, which lowers the portability. Moreover, since the biometrics processing is performed by an authentication device, the authentication device requires a sophisticated processing device, which increases the device cost.

It is therefore an object of the present invention to provide an authentication control configuration and an authentication procedure which can be appropriately used in an information processing device such as a laptop type personal computer.

In order to achieve the aforementioned object, an information processing device according to the present invention includes: a biometrics device, and interface control unit for controlling the biometrics device, a first storage unit for concealing a user identifier and user authentication information, a second storage unit for storing a program executed by the information processing device, and a processor for releasing the concealment of the first storage unit based on the program stored in the second storage unit and acquiring biometrics information inputted from the biometrics device via the interface control unit, so as to compare it to the user authentication information.

Moreover, the information processing device according to the present invention includes: a first nonvolatile storage unit for storing encrypted biometrics information, a second nonvolatile storage unit for storing an encryption key of the biometrics information, a lock release unit for releasing access lock of the first nonvolatile storage unit and the second nonvolatile storage unit, a decryption unit for decrypting the biometrics information by the encryption key of the biometrics information and recording it in the volatile storage unit, and an authentication unit for comparing the biometrics information decrypted by the volatile storage unit and the biometrics information acquired by a biometrics device, thereby performing authentication.

According to the present invention, the authentication device can be built in a laptop type personal computer without lowering its portability, thereby configuring a laptop type personal computer of high security at a low cost.

Other objects, features and advantages of the invention will become apparent from the following description of the embodiments of the invention taken in conjunction with the accompanying drawings.

### BRIEF DESCRIPTION OF THE DRAWINGS

FIG. 1 shows a system configuration of an embodiment;

FIG. 2 is an external view of the device according to the embodiment;

FIG. 3A is an external view of a finger vein sensor according to the embodiment and FIG. 3B shows the finger vein sensor in a used state;

FIG. 4 is a circuit diagram of the finger vein sensor interface according to the embodiment;

FIG. 5 shows a system state transition of the embodiment;

FIG. 6 shows a flow of the system start according to the embodiment;

FIG. 7 shows a flow of the vein authentication procedure according to the embodiment;

FIG. 8 shows an outline of the authentication data processing; and

FIG. 9 shows an outline of another processing of the authentication data.

### DESCRIPTION OF THE EMBODIMENTS

Description will now be directed to an embodiment of the present invention with reference to the attached drawings.

In the figures, portions identical or similar to those of other figures in their operations or configurations are referred to by the common symbols, with explanation thereof being omitted.

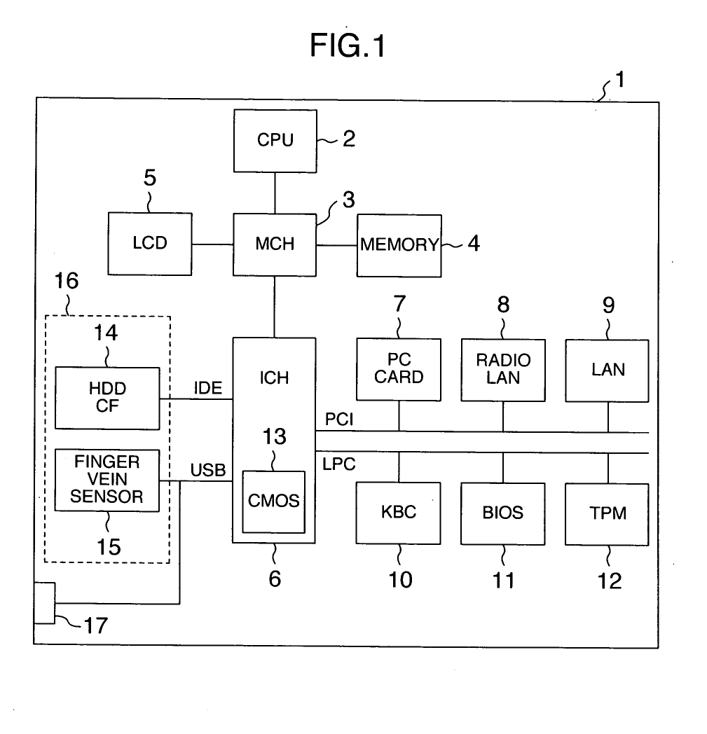

FIG. 1 shows a hardware configuration of a laptop type personal computer according to the embodiment of the present invention. In the personal computer 1, an operating system of the computer and a user application program are executed by a processor 2. These software are read from a storage device such as a hard disc and stored in a memory 4 connected to a memory controller 3. Furthermore, the memory controller 3 is connected to an LCD 5 which is a display unit of the computer.

Moreover, the memory controller 3 is connected to an I/O controller for controlling an I/O device. The processor 2 controls the I/O device via the memory controller 3 and the I/O controller 6.

In the personal computer of the present embodiment, a PCI bus of the I/O controller 6 is connected to a PC card controller 7, a radio LAN 8, and a cable LAN 9. Moreover, an LPC (Low Pin Count) interface is connected to keyboard controller 10, a BIOS-ROM 11, and a security chip 12.

Here, the security chip 12 is a controller having a memory for storing an encryption key, an RSA encryption function, a random number generation function, and an encryption function such as the Hash function. That is, the security chip 12 is hardware for supporting the security management of the personal computer. For example, it is possible to encrypt a file of the storage device such as a hard disc by the encryption function of the security chip 12.

The I/O controller .6 has a built-in CMOS memory 13 backed up by a battery. The CMOS memory 13 contains configuration information on the personal computer 1, a BIOS password, and the like. The log-in procedure using the BIOS password will be detailed later.

Moreover, the I/O controller 6 is connected to the storage device 14 such as a hard disc device (HDD) and a Compact Flash (trade mark) via an IDE bus. These storage devices 14 contain the operating system and the user application program and can store user data encrypted by the security chip 12.

Furthermore, the I/O controller 6 has a built-in controller of universal serial bus (USB) and connected to. a finger vein sensor 15 via the USB. The USB is also connected to a USB connector 17, so that a secure memory card and an external biometrics device can be connected to outside the device.

In the personal computer of the present embodiment, the storage device 14 connected to the IDE bus and a control circuit of the finger vein sensor 15 are formed as a unitary block, i.e., a module configuration 16. Next, explanation will be given on the outline of the finger vein device.

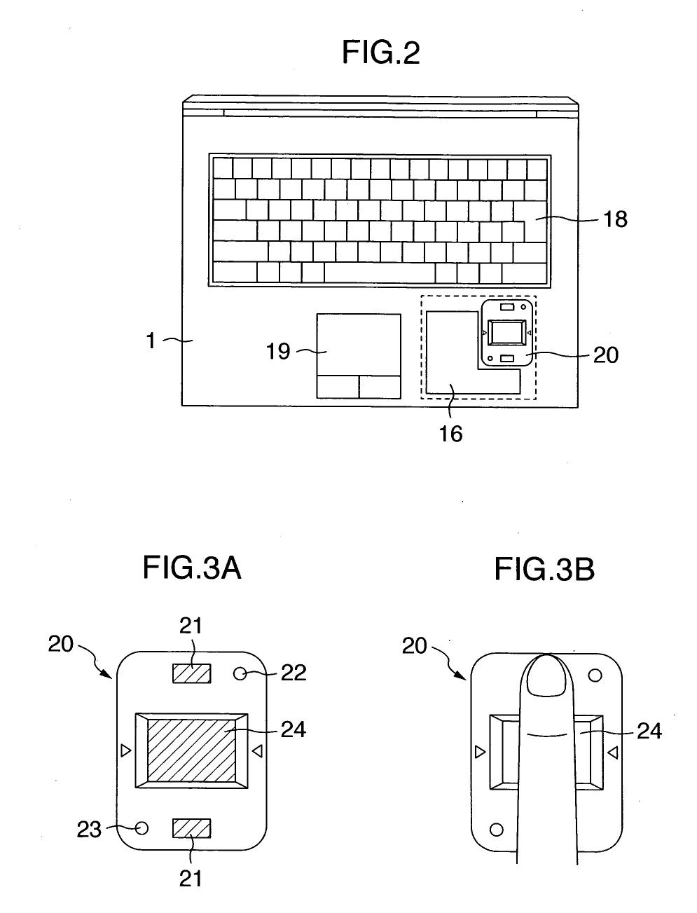

FIG. 2 is a plan view of the upper surface of main body of the personal computer 1 where a keyboard 18 is arranged. A track pad 19 as a pointing device is arranged at a palm rest portion at the front of the main body and the finger vein sensor 20 is arranged at the right of the track pad 19. In the personal computer 1 of the present embodiment, by mounting the finger vein sensor 20 and its interface module 16 at the area where a 2.5-inch HDD is to be mounted. This reduces the entire size of the device. A storage device of the CF type can be mounted on the interface module 16. Details will be explained later. The storage device of the CF type has lower storage capacity as compared to the model where a 2.5-inch HDD is mounted. However, the CF type storage device can store a basic operating system and a user application program and has a high shock-resistance. This improves reliability of the personal computer 1.

FIG. 3A shows an outline of the finger vein sensor 20. In the finger vein sensor 20, near infrared rays irradiation windows 21, 22 are arranged above and below a finger vein imaging window 24. Inside the near infrared rays irradiation windows 21, 22, near infrared ray LED's are arranged. As shown in FIG. 3B, a user of the personal computer 1 puts the first joint of his/her finger at the center of the imaging window 24 of the finger vein sensor 20. The near infrared rays emitted from the LED's pass through the finger and the transmission light is imaged by a camera arranged below the imaging window 24. Here, because of the difference in absorption ratio of near infrared rays by the blood, a finger vein blood vessel pattern can be imaged. Each person has a different finger vein blood vessel pattern and it can be used as biometrics information.

Since the imaging window 24 is arranged open on the upper portion of the personal computer 1, external turbulence and light are also inputted. For this, a visible light cut filter is arranged to reduce the affect of the external turbulence light. Moreover, operation display LED's '22, 23) are arranged to indicate the operation state of the finger vein sensor 20.

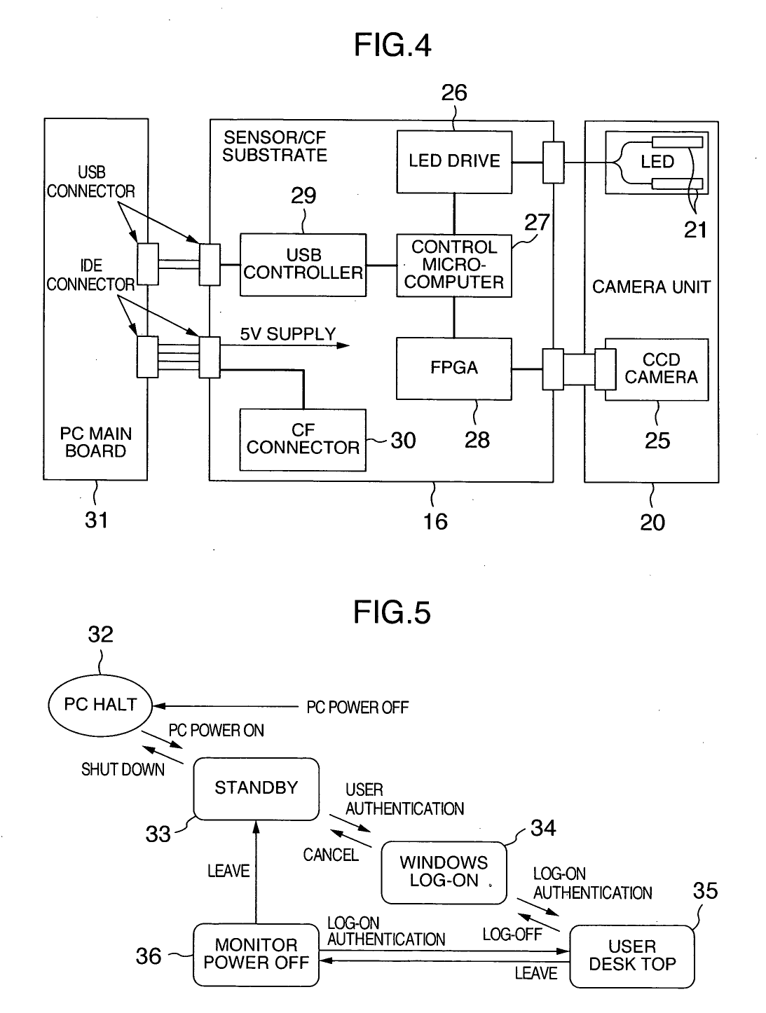

Next, referring to FIG. 4, explanation will be given on the configuration of the interface control circuit of the finger vein sensor 20. As has been described above, the finger vein sensor 20 is formed by the near infrared ray LED (21) and a CCD camera 25. Light emission of the near infrared ray LED (21) is controlled by an LED drive circuit 26 of a sensor/CF substrate 16. Moreover, the CCD camera 25 is controlled by a field programmable gate array (FPGA) 28 of the sensor/CF substrate 16 so as to generate image data on the finger vein. The LED drive circuit 26 and the FPGA 28 are controlled from a PC main board 31 via a control microcomputer 27 and a USB controller 29. The image data on the finger vein is obtained by imaging the vein pattern of the finger placed on the imaging window 24 of the finger vein sensor 20 in accordance with the finger vein data request of the PC main board 31 and is transmitted to the PC main board 31. This image data is used for performing user authentication, which will be detailed later.

The sensor/CF substrate 16 is connected to an USB interface performing interface with the finger vein sensor 20 and the IDE interface as a control interface of the recording device. The IDE interface is connected to a CF connector 30 to which a CF type recording device formed by a flash memory can be connected. Moreover, the sensor/CF substrate 16 and the finger vein sensor 20 are drive by power supplied from the IDE connector.

In this embodiment, the sensor/CF substrate 16 and the finger vein sensor 20 are formed with a size/capacity equivalent to or smaller than a 2.5-inch HDD. Thus, it is possible to provide the sensor/CF substrate 16 instead of the 2.5-inch HDD. That is, without modifying other components of the personal computer 1, it is possible to mount the biometrics device such as the finger vein sensor 20. As has been described above, the CF type storage device stores a basic operating system and a user application program.

Next, referring to FIG. 5, explanation will be given on the state transition of the personal computer 1 of the embodiment. State 32 indicates a state when no power is supplied to the personal computer 1. When a power ON switch is pressed in this state, power is supplied to the personal computer 1 and the device is started. Upon completion of initialization of the I/O device of the personal computer 1, a user authentication wait state (standby 33) is set in. If this standby state continues for a long time, shut down is performed automatically. When a user of the personal computer 1 inputs an authentication code in the standby state 33, a system long-On state 34 is set in. If the system log-on is successful, further long-on authentication of the network system is performed and a desk top state 35 is set in as a use environment for the user.

If the personal computer 1 is left for a predetermined time in the desk top state 35, a monitor power supply is turned off. In order to resume the desk top state 35, the log-on authentication should be performed again. This assures security of the personal computer 1 when the user of the personal computer 1 leaves his/her seat.

Authentication of the personal computer 1 of the present embodiment is performed at two stages: user authentication and log-on authentication. The authentication procedure will be detailed below.

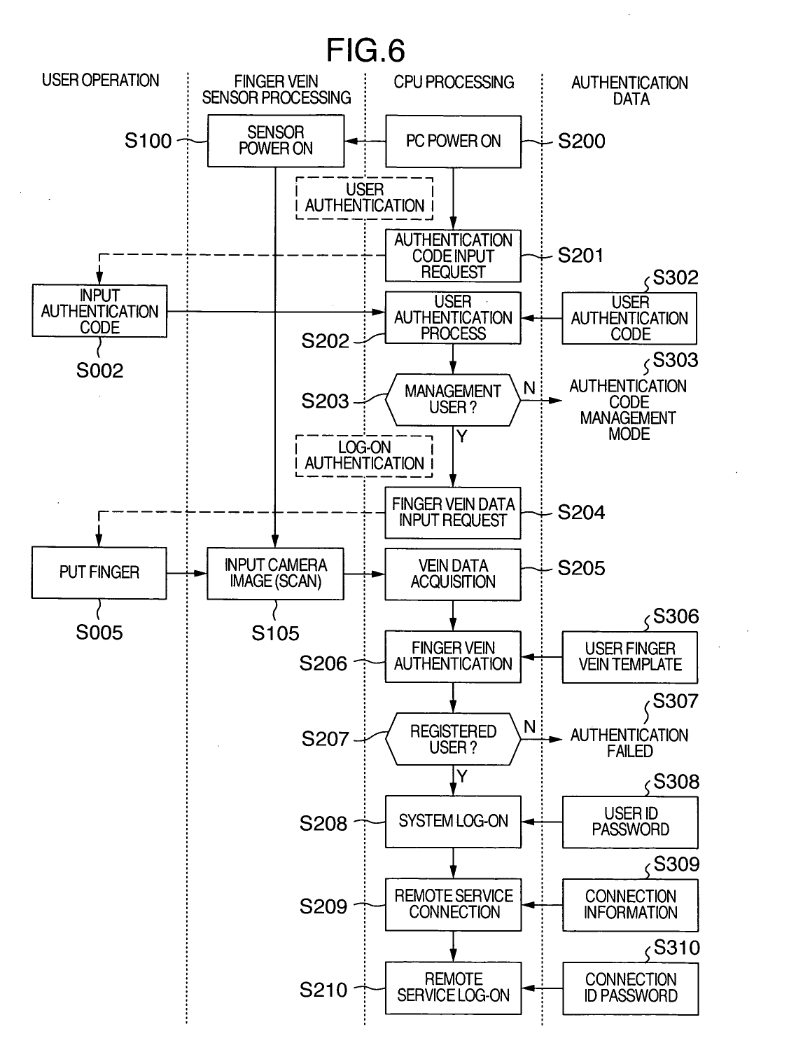

FIG. 6 is a diagram showing the authentication procedure from power ON to completion of a remote service. In FIG. 6, the processing procedure is shown in four aspects: the user operation, the processing contents of the finger vein sensor, the CPU processing of the personal computer 1, and the authentication data type. When the PC power is turned ON at S200, the vein sensor power is also turned ON (S100). After the power is turned ON (S200), the CPU requests a user to input an authentication code (S210). The user of the personal computer 1 inputs the authentication code in response to the authentication code input request (S002).

The CPU 2 reads out the authentication code recorded in the personal computer 1 in advance (S302) and compares the read out authentication code to the authentication code inputted by the user (S202). If the comparison results in mismatching, an authentication code input error is caused and re-input is requested. When a predetermined number of input errors are caused, the user authentication processing is terminated and the personal computer 1 enters the standby state.

If the comparison shows that the authentication code has been registered one, it is judged whether the inputted authentication code is an authentication code of an administrator (S203). If the code is the authentication code of the administrator, the authentication code management mode is started. Although details are omitted here, the management mode performs registration of a new user and modification of the authentication code.

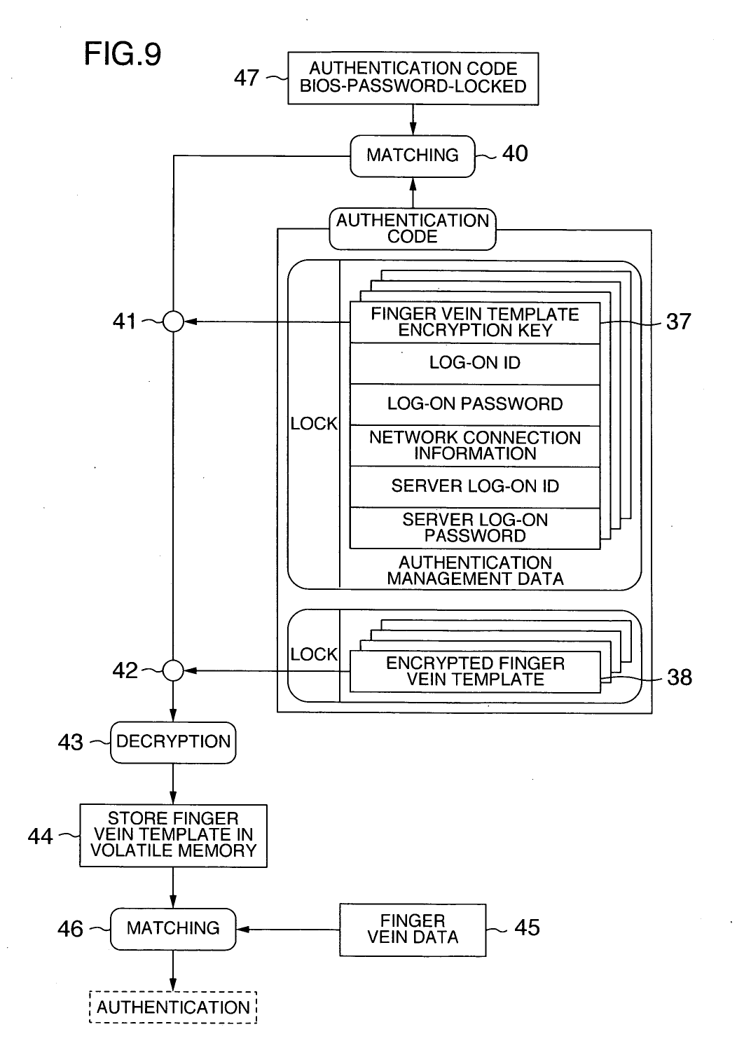

Here, as the authentication code, a plurality of digits of alphanumeric characters are inputted through keyboard operation. When the authentication code input is correct, it is possible to access authentication information such as a finger vein template, user ID/password, connection information, and a connection ID which will be detailed below. When the authentication code is complicated, security of the authentication information is increased but operability may be lowered. In order to improve the operability, the authentication information is recorded on a secure memory card, so that access can be performed via a USB connector 17 as shown in FIG. 9 and FIG. 10.

When the registered authentication code is inputted, it is assumed that an authorized user is operating the personal computer and the next log-on authentication is performed.

The CPU 2 requests the user to input finger vein data (S204). In response to this, the user places his/her finger on the imaging window of the finger vein sensor (S205). Upon detection of a finger, the finger vein sensor inputs a camera image of the vein pattern by near infrared rays (S105). The CPU 2 acquires the imaged vein pattern (S205) and reads out the user finger vein template from the authentication information which has been unlocked (S306). A pattern matching is performed between the vein data acquired from the finger vein sensor and the user finger vein template so as to perform finger vein authentication processing (S206). If the result of the pattern matching (S207) is mismatching, it is judged that the authentication of the registered user has failed (S307). If the result of the pattern matching (S207) is matched, it is judged that the user is the registered user and a system log-on process (S208) is performed.

In the system log-on process (S208), a user ID and a password are read out from the authentication information (S308) and the system log-on is performed. Next, network connection information is read out from the authentication information (S309) and connection to the network is performed (S209). After this, a connection ID and a password of a remote server are read out from the authentication information (S310) and the server log-on process is performed (S210).

According to the aforementioned procedure, the user inputs the authentication code, so that the user finger vein authentication is performed and the system log-on process is automatically performed. Since the authentication is performed at the two stages, i.e., the authentication code and the finger vein pattern, it is possible to assure the system security and conceal the finger vein pattern and the connection information.

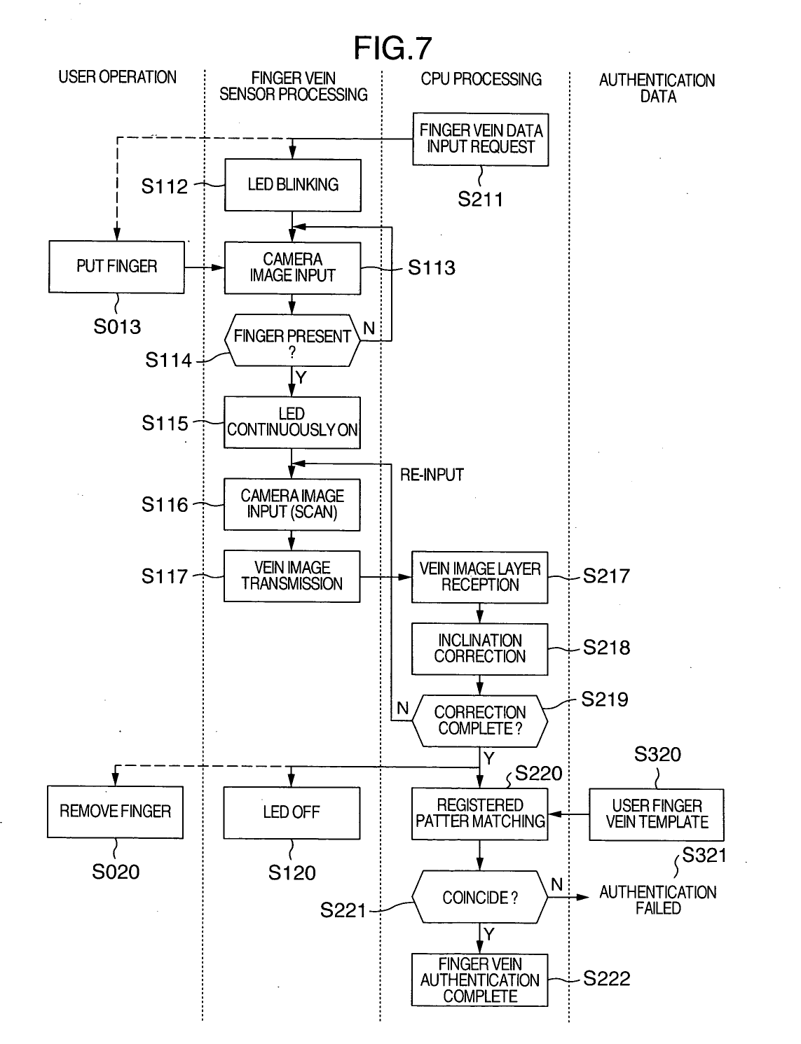

Next, referring to FIG. 7, explanation will be given on the finger vein authentication sensor processing.

Upon a finger vein data input request by the CPU 2 (S211), the control microcomputer 27 of the finger vein authentication sensor controls the near infrared ray LED (21) to blink (S112). In this state, a CCD camera 25 images a vein pattern of the finger of the user placed on the imaging window (24) of the finger vein authentication sensor (S113). The obtained image data is used to judge whether a finger exists (S114). When it is judged that a finger is placed on the imaging window (24), the control microcomputer 27 controls the near infrared ray LED (21) to a continuously ON state (S115) and images the vein pattern of the user's finger placed on the imaging window 24 of the finger vein authentication sensor (S116). The imaged finger vein pattern is transmitted to the CPU 2.

Here, when the near infrared ray LED (21) is controlled to blink, since a high-output LED light emission can be performed, a camera sensitivity may be lowered. Accordingly, it is possible to reduce the affect of the external turbulence light and easily judge whether user's finger is placed.

The CPU 2 receives the vein pattern image from the finger vein authentication sensor (S217) and performs image inclination correction (S217). This is performed for accurately performing the matching process with the user finger vein template. If the inclination cannot be corrected, the finger vein pattern is again acquired (S219).

After the inclination of the vein pattern is corrected, the CPU 2 acquires the user finger vein template from the authentication information (S320) and performs a matching process between the vein pattern acquired from the finger vein authentication sensor and the finger vein template (S320). If the matching process results in a low matching ratio, the authentication has failed (S321). If the matching process results in a predetermined matching ratio or above, the authentication is completed. Moreover, after the inclination of the vein pattern is corrected, the CPU 2 turns OFF the near infrared LED (21) of the finger vein authentication sensor (S120).

Thus, the control microcomputer 27 of the finger vein authentication sensor controls the near infrared ray LED (21), detects a finger, and images a vein pattern image while the CPU 2 of the personal computer performs the matching process of the vein pattern. That is, the pattern matching process requiring a large processing load is not performed by the control microcomputer 27 of the finger vein authentication sensor and accordingly, the control microcomputer 27 may be a low-performance microcomputer, which reduces the cost of the finger vein authentication sensor and the device size.

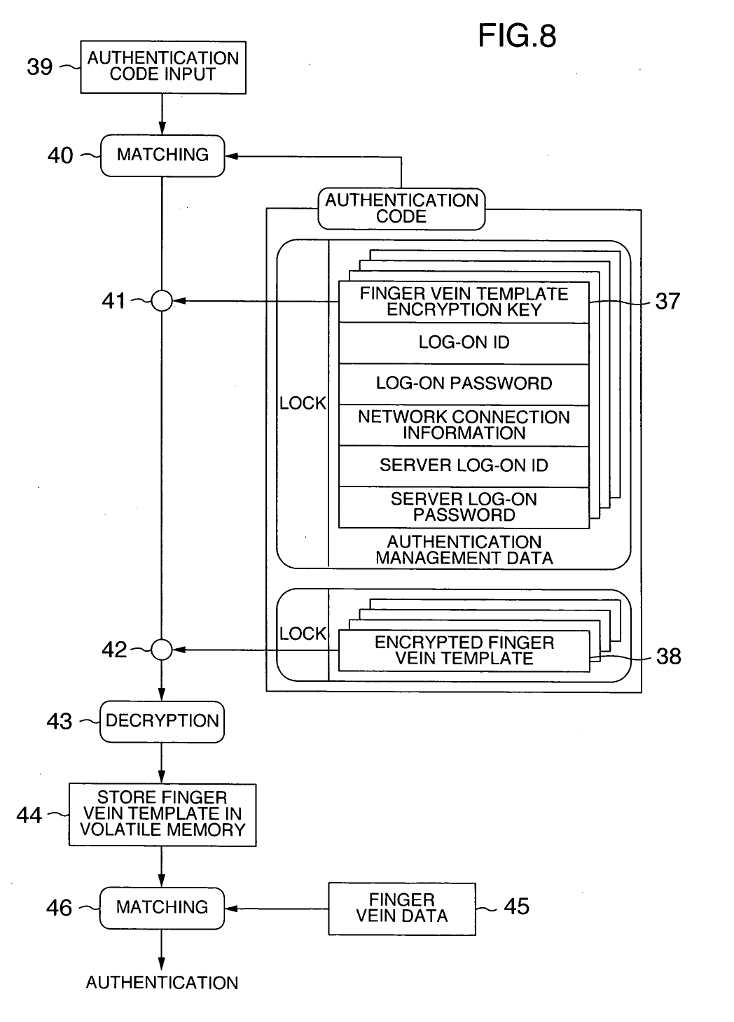

Next, referring to FIG. 8, explanation will be given on the authentication information managing method.

The authentication information is formed by: authentication management data 37 including a finger vein template encryption key, a log-on ID, a log-on password, network connection information, a remote log-on ID, and remote server log-on password; and encrypted finger vein template; each of which is access locked by an authentication code. The authentication management data 37 and the encrypted finger vein template information 38 are provided for each of the users using thye personal computer 1.

The authentication management data 37 and the encrypted finger vein template information 38 are recorded on a security chip 12. When the storage capacity of the security chip 12 is small, the encrypted finger vein template information 38 may be stored in the storage device such as an HDD. In this case also, the finger vein template information 38 is encrypted and the encryption key is locked by the authentication code, which assures security.

As has been described in FIG. 6, when the authentication code is inputted (39), it is compared to the authentication code of the security chip 12 (40 and the access lock of the authentication management data 37 is released, so that the finger vein template encryption key can be accessed (41). Similarly, access lock of the encrypted finger vein template information 38 is also released (42). The finger vein template encryption key and the encrypted finger vein template information are read out from the security chip 12 and decrypted on the volatile memory of the memory 4, thereby preparing the finger vein template. After this, the finger vein data (45) inputted from the finger vein authentication sensor is compared to the finger vein template decrypted on the memory for performing user authentication (46). Thus, the finger vein template information is encrypted when stored in the security chip 12 and its concealment can be maintained. The decrypted finger vein template information is temporarily stored in the volatile memory and no data leak is caused.

FIG. 9 shows an embodiment for achieving user operability by eliminating the authentication code input for releasing the lock of the security chip 12. In stead of the authentication code input of FIG. 8, an authentication code which is BIOS password-locked is stored in the CMOS memory 13 in advance. The authentication management data 37 and the encrypted finger vein template information 38 which are unlocked by the authentication code are stored in a secure memory card to be connected to the USB interface or the like. When the secure card is mounted and power of the personal computer 1 is turned ON, the authentication code 47 in the CMOS memory 13 is compared to the authentication code of the secure memory card. If they coincide, the secure memory card is unlocked. The process after this is identical to FIG. 8. In the example of FIG. 9, the system log-on is performed if the finger vein pattern biometrics coincide and the secure memory card is held and accordingly, it is possible to assure the security of the finger vein template information.

It should be further understood by those skilled in the art that although the foregoing description has been made on embodiments of the invention, the invention is not limited thereto and various changes and modifications may be made without departing from the spirit of the invention and the scope of the appended claims.

1. An information processing device performing authentication by biometrics information comprising:
a biometrics device,
a first storage unit which is access-locked to conceal a user identifier and user authentication information stored corresponding to an authentication code,
a second storage unit which stores a program executed by the information processing device, and
a processor which releases the access lock of the first storage unit based on the program stored in the second storage unit and acquiring biometrics information inputted from the biometrics device, so as to perform biometrics authentication based on the user authentication information in the first storage unit.

2. The information processing device as claimed in claim 1, further comprising:
a supply unit which supplies an authentication code,
wherein the processor compares the authentication code corresponding to the user identifier and the user authentication information with the authentication code supplied from the supply unit and releases the access lock of the first storage unit so that the user identifier and the user authentication information can be accessed if the authentication codes coincide.

3. The information processing device as claimed in claim 2, wherein
the authentication code supply unit is a CMOS region which is BIOS password-locked, and
the first storage unit is a a security chip or a secure memory card.

4. The information processing device as claimed in claim 2, wherein
a part of the user authentication information is encrypted by the security chip and stored in the second storage unit, and
the encrypted user authentication information is decrypted by the security chip upon acquisition of information.

5. The information processing device as claimed in claim 2, wherein
the user authentication information includes encrypted biometrics authentication information,
the user identifier includes an encryption key of the encrypted biometrics authentication information, and
when the authentication codes coincide, the processor decrypts the encrypted biometrics authentication information contained in the user authentication information by the encryption key contained in the user identifier, thereby performing biometrics authentication.

6. The information processing device as claimed in claim 5, wherein
the user identifier includes a log-on ID and a log-on password, and
when the biometrics authentication is successful, the processor acquires the log-on ID and the log-on password from the user identifier and performs a log-on process according to the log-on ID and the log-on password.

7. The information processing device as claimed in claim 6, further comprising
a network connection unit,
wherein the user identifier includes network connection information, a server log-on ID and a server log-on password, and
when the biometrics authentication is successful and the log-on process is successful, the processor acquires the network connection information, the server log-on ID, and the server log-on password from the user identifier, makes a connection to a remote service according to the network connection information and performs a log-on process of the remote service according to the server log-on ID and the server log-on password.

8. An information processing device performing authentication by biometrics information comprising:
a first nonvolatile storage unit which stores encrypted biometrics information,
a second nonvolatile storage unit which stores an encryption key of the biometrics information,
a volatile storage unit used by a program of the information processing device,
a decryption unit which decrypts the biometrics information by the encryption key of the biometrics information and recording it in the volatile storage unit, and
an authentication unit which compares the biometrics information decrypted by the volatile storage unit and the biometrics information acquired by a biometrics device, thereby performing authentication.

9. The information processing device as claimed in claim 8, wherein
the first nonvolatile storage unit and the second nonvolatile storage unit are access-locked for concealing the recorded information,
the access-lock of the first nonvolatile storage unit and the second nonvolatile storage unit is released by lock release unit,
the lock release unit releases the access lock when an authentication code recorded in advance according to the encryption key of the biometrics information is inputted.

10. The information processing device as claimed in claim 9, where
the first nonvolatile storage unit is included in an HDD where the program of the information processing device is recorded.

11. An authentication method of an information processing device comprising an authentication device, the method comprising steps of:
recording a user identifier and user authentication information for an authentication code in a nonvolatile storage unit which can be security-locked,
releasing the access-lock of the nonvolatile storage unit by the inputted authentication code,
acquiring user authentication information from the nonvolatile storage unit, and
performing authentication by using the user authentication information and user authentication information which has been inputted.

12. The authentication method of an information processing device as claimed in claim 11, further comprising steps of:
acquiring an encryption key of user authentication information from the user identifier of the non volatile storage unit,
decrypting the user authentication information acquired from the nonvolatile storage unit by the encryption key,
storing the decrypted user authentication information in the volatile storage unit, and
performing authentication by using the authentication information and user authentication information which has been inputted.

13. The authentication method of an information processing device as claimed in claim 11, further comprising a step of:
setting the information processing device to a standby state if the inputted authentication code is unauthorized.

14. The authentication method of an information processing device as claimed in claim 11, further comprising steps of:
judging whether the inputted authentication code is an authentication code for an administrator, and
registering a new user and modifying the authentication code when the code is an authentication code for the administrator.

15. The authentication method of an information processing device as claimed in claim 11, further comprising:
a step of inputting a plurality of digits of alphanumeric characters through keyboard operation to input an authentication code, or
a step of inputting an authentication code by acquiring a code recorded in advance in a CMOS memory which is BIOS password-locked.

16. The authentication method of an information processing device as claimed in claim 11, further comprising steps of:
acquiring a log-on ID and a log-on password contained in the user identifier of the nonvolatile storage unit after authentication by the inputted user authentication information, and
performing a system log-on process by the log-on ID and the log-on password.

17. The authentication method of an information processing device as claimed in claim 16, further comprising steps of:
acquiring network connection information, a server log-on ID, and a server log-on password contained in the user identifier of the nonvolatile storage unit after the system log-on process,
making a connection to a remote service by the network connection information, and
performing a remote service log-on process by the server log-on ID and the server log-on password.
